(19) United States
(12) Patent Application Publication
(10) Pub. No.: US 2021/0215323 A1
(43) Pub. Date: Jul. 15, 2021

(54) LIGHT-FIXTURE APPARATUS WITH HIDDEN MOUNTING GEARS

(71) Applicant: Alloy LED, LLC, Emeryville, CA (US)

(72) Inventors: Joe Flynn, Emeryville, CA (US); Max Darling, Emeryville, CA (US)

(21) Appl. No.: 17/089,964

(22) Filed: Nov. 5, 2020

Related U.S. Application Data
(60) Provisional application No. 62/958,745, filed on Jan. 9, 2020.

(51) Int. Cl. F21V 17/06; F21S 4/28

(52) U.S. Cl. CPC F21V 17/06; F21Y 2103/10; F21S 4/28

(57) ABSTRACT

A light-fixture apparatus may be provided that comprises a light source, one or more mounting gears, and a low-profile extrusion comprising a first structure to house the one or more mounting gears. The one or more mounting gears are completely hidden under the first structure of the low-profile extrusion, where the first structure is the undercarriage of the low-profile extrusion.

### TECHNOLOGICAL FIELD

The present disclosure generally relates to a light-fixture apparatus, and more particularly relates to an extrusion of the light-fixture apparatus that completely hides one or more mounting gears coupled with the extrusion to hold the light-fixture apparatus on to a surface.

### BACKGROUND

A light-fixture or luminaire is an electrical apparatus that holds one or more light sources and is used for the purpose of illumination. The light-fixture houses the one or more light sources and controls the one or more light sources to control illumination intensity of light emitted from the one or more light sources.

Generally, a linear light-fixture apparatus comprises an extrusion profile, mounting gears, or a diffuser which are assembled together to build the light-fixture apparatus. However, the currently available light-fixture apparatuses are assembled such that the mounting gears are visible which decreases the aesthetic appeal of the light-fixture apparatuses. Moreover, the process of coupling or decoupling of the mounting gears with the extrusion in currently available light-fixture apparatuses is not smooth and convenient, which makes cleaning of the light-fixture apparatuses difficult. Lack of proper cleaning results in poor illumination as well as reduced life of the light-fixture apparatuses.

### SUMMARY

Accordingly, the present disclosure provides a light-fixture apparatus that comprises a low-profile extrusion which completely hides one or more mounting gears used for mounting the light-fixture apparatus on to a surface. The light-fixture apparatus, comprising a light source; the one or more mounting gears; and the low-profile extrusion comprising a first structure to house the one or more mounting gears, wherein the one or more mounting gears are completely hidden under the first structure of the low-profile extrusion.

According to some example embodiment, the first structure corresponds to an undercarriage, and where the one or more mounting gears are removably coupled to the undercarriage.

According to some example embodiment, the low-profile extrusion further comprising a second structure to house the light source.

According to some example embodiment, the one or more mounting gears comprise one or more mounting clips. Further, the one or more mounting clips hold the low-profile extrusion on to a surface by removably locking with the first structure of the low-profile extrusion.

According to some example embodiment, the one or more mounting clips are flexible. The one or more mounting gears comprise a bent sheet metal. Further, the one or more mounting clips are also made of the bent metal sheet. Further, the low-profile extrusion comprises aluminum material, and the low-profile extrusion protects the light source.

According to some example embodiment, the light-fixture apparatus further comprising a cover overlaid on the light source, where the cover is transparent and is removably coupled with the low-profile extrusion.

According to some example embodiments, the cover corresponds to a diffuser that scatters light from the light source, where the diffuser comprises plastic material.

According to some example embodiments, the cover corresponds to a lens that controls the light emitting from the light source, and directs the light according to a predefined beam pattern associated with the lens.

According to some example embodiment, the light-fixture apparatus further comprising a plurality of endcaps configured to hold together the light source, the low-profile extrusion, and the cover.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 illustrates an exploded view of light-fixture apparatus, in accordance with an example embodiment;

FIG. 2A illustrates a side view of a low-profile extrusion coupled with a mounting gear, in accordance with an example embodiment;

FIG. 2B illustrates a structure of a mounting gear and structures of mounting clips, in accordance with an example embodiment;

FIG. 3 illustrates a front view of the light-fixture apparatus, in accordance with an example embodiment;

FIG. 4 illustrates a rear view of the light-fixture apparatus, in accordance with an example embodiment; and

FIG. 5 illustrates an exemplary scenario for implementation of the light-fixture apparatus, in accordance with an example embodiment.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments. Thus, use of any such terms should not be taken to limit the spirit and scope of embodiments of the present invention.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

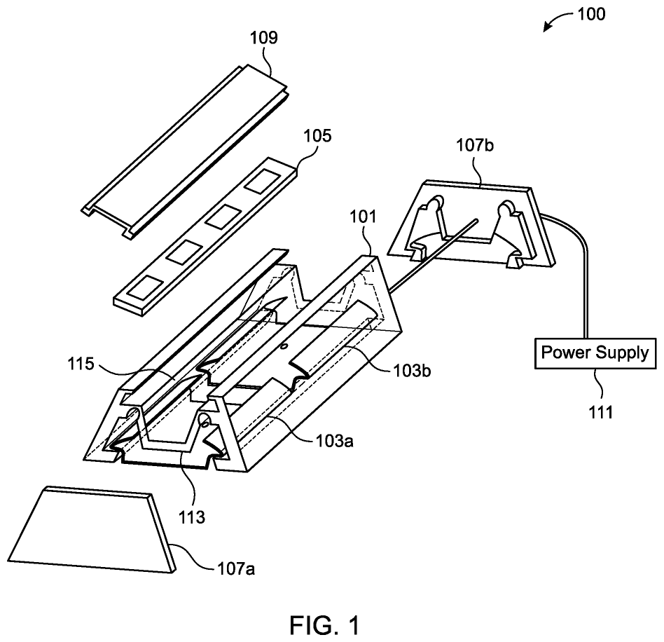

A light-fixture apparatus may be provided for better illumination of surroundings. The light-fixture apparatus are designed to house a light source and optionally a power supply in order to control the power supplied to the light source. Alternatively, the light-fixture apparatus may also connect the light source to an external power supply, for example, but not limited to, AC mains power supply, to power on the light source. In an example embodiment, the light-fixture apparatus may be battery powered. The light source may be a light emitting diode (LED), a fluorescent bulb, an incandescent bulb, and/or the likes. The light-fixture apparatus comprises at least one light source, a low-profile extrusion, and one or more mounting gears to engage with the low-profile extrusion to hold the light-fixture apparatus on to a surface. The low-profile extrusion is a small sized extrusion that may be used to hold the at least one light source. The low-profile extrusion may be obtained by a process of forcing or pushing a material (for example, but not limiting to, aluminum or the like) through a low-profile (small sized) die of a desired shape. The shape of the low-profile extrusion is explained briefly in FIG. 1. The low-profile extrusion comprises a first structure forming an undercarriage, where the one or more mounting gears are removably coupled to the undercarriage to mount the light-fixture apparatus onto the surface. The light-fixture apparatus provides for easier cleanup of the light-fixture and easier installation of the light-fixture apparatus. These and other technical improvements of the invention will become evident from the description provided herein.

FIG. 1 illustrates an exploded view of the light-fixture apparatus 100, in accordance with an example embodiment. The light-fixture apparatus 100 comprises a low-profile extrusion 101, one or more mounting gears 103a, 103b, a light source 105, one or more endcaps 107a, 107b, a cover 109, and a power supply 111. The light-fixture apparatus 100 houses the light source 105 and controls the power supplied to the light source 105 to control an intensity of illumination by the light source 105. The light-fixture apparatus 100 may also connect the light source 105 to the external power supply 111, for example AC mains power supply, to power on the light source 105. The low-profile extrusion 101 comprises an undercarriage-like first structure 113 and a second structure 115.

The one or more mounting gears 103a, 103b may be removably coupled to the first structure 113. The one or more mounting gears 103a, 103b are used to engage with the low-profile extrusion 101 to mount the light-fixture apparatus 100 on to a surface, for example under or inside cabinets, on walls, on ceilings, inside vehicles (for example trains, buses, cars, airplanes or the likes), or the likes. Further, the second structure 115 holds the light source 105. The cover 109 is removably coupled with the second structure 115. The cover 109 is overlaid on the light source 105 and is transparent. In an example embodiment, the cover 109 may be a diffuser that acts as a light-scattering medium placed in the path of the light source 105 to reduce the sharpness of shadows and thus soften the lighting emitted from the light source 105. In an example embodiment, the cover 109 may be a lens. The cover 109 is used to seal the light-fixture apparatus 100 from an illumination side (may interchangeably referred as “front portion”) of the light-fixture apparatus 100. The cover 109 is removably coupled with the low-profile extrusion 101. The one or more endcaps 107a, 107b, are configured to hold together the light source 105, the low-profile extrusion 101, and the cover 109. Further, the light-fixture apparatus 100 is connected to the power supply 111 to power the light source 105.

As illustrated in the FIG. 1, a rear portion of the light-fixture apparatus 100 is used to mount the light-fixture apparatus 100 on to the surface. The rear portion includes the one or more mounting gears 103a, 103b, removably locked with the first structure 113 of the low-profile extrusion 101. The front portion of the light-fixture apparatus 100 is used for illumination of the surroundings. The front portion may comprise the second structure 115 of the low-profile extrusion 101, the light source 105, and the cover 109. Further, the side portions (for example, a left-side portion and a right-side portion) of the light-fixture apparatus 100 include the endcaps 107a, 107b to hold together the light source 105, the low-profile extrusion 101, and the cover 109.

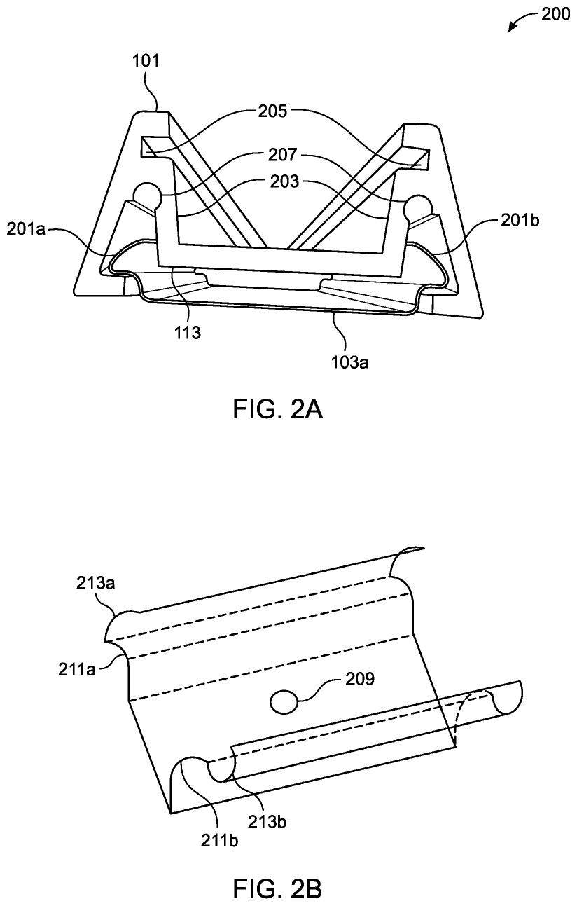

The one or more mounting gears 103a, 103b may be mounted on to the surface by using one or more fasteners. The one or more fasteners may include, but are not limited to screws, nuts and bolts, rivets, concrete anchors, inserts, or the likes. Each mounting gear of the one or more mounting gears 103a, 103b comprises a structure that allows one or more fasteners to attach the one or more mounting gears 103a, 103b with the surface. Further, the one or more mounting gears 103a, 103b comprise one or more mounting clips 201a, 201b (shown in FIG. 2). The one or more mounting clips 201a, 201b are flexible and are used to removably inter-lock (interchangeably referred as “lock”) with the first structure 113, which means that the first structure of the low-profile extrusion 101 fits into the one or more mounting gear 103a, 103b by snapping into the flexible mounting clips 201a and 201b. The one or more mounting gears 103a, 103b fits completely into the low-profile extrusion 101 such that one or more mounting gears 103a, 103b adds no height to the overall structure of the low-profile extrusion after getting inter-locked with the low-profile extrusion 101.

The cover 109 may be a diffuser, where the diffuser is a translucent or semi-transparent cover that spreads out or scatters light from the light source 105 housed by the light-fixture apparatus 100. The diffuser may be used to control brightness of the light emitted from the light source 105. It may be used to make bright or harsh light softer across a wider area for proper illumination of the surroundings. In case of LED light source 105, the diffuser may avoid creation of LED hotspots. In an example embodiment, the diffuser may be made of plastic. Further, the diffuser may be made up of a material including but not limited to glass, acrylic, or polycarbonate.

In an example embodiment, the cover 109 may be a lens. Unlike the diffuser that spreads or scatters the light emitting from the light source 105, the lens controls the light emitting from the light source 105, and directs the light according to a predefined beam pattern associated with the lens. In an example embodiment, the cover 109 may be transparent and does not produce any optical effect on the light emitting from the light source 105.

The light source 105 may be a strip of LEDs, a fluorescent light source, incandescent light source, or the likes. The low-profile extrusion 101 may be made up of a material including but not limited to different metals or alloys, cold rolled steel, stainless steel, copper, and brass. In a preferred embodiment, the low-profile extrusion 101 may be made up of aluminum or aluminum alloy (for example alloy 6063). The aluminum makes the low-profile extrusion lightweight and corrosion free. Further, due to good thermal conductivity of the aluminum, the low-profile extrusion 101 made up of aluminum may act as heat sink for dissipation of heat produced in case of LED light source.

Further, the one or more mounting gears 103a, 103b are made up of a sheet metal. The sheet metal is bent to form each mounting gear of the one or more mounting gears 103a, 103b to flexibly engage into the first structure 113 of the low-profile extrusion 101. The sheet metal may be made up of different metals for example aluminum, brass, copper, steel, tin, nickel, titanium, silver, gold, and platinum.

In another embodiment, the one or more mounting gears 103a, 103b may be mounted on a cord, chain, or metal rod suspended from a ceiling to hold the low-profile extrusion 101 in order to form a pendant light-fixture.

It shall be noted that although the power supply 111 is shown as external power supply, however an ordinary skilled in the art will appreciate that the power supply may also be integrated within the light-fixture apparatus 100 without deviating from the scope of the invention. Further, a single light source 105 is shown for illustrative purposes, but it shall be noted that multiple light sources with similar or different characteristics may also be housed by the light-fixture apparatus 100.

FIG. 2A illustrates a side view 200 of the low-profile extrusion 101 coupled with mounting gear 103a, in accordance with the example embodiment. The side view 200 corresponds to the side portion of the light-fixture apparatus 100 as explained in FIG. 1. The mounting gear 103a (mounting gear 103b not visible in the figure but coupled with the low-profile extrusion 101 in the same manner as the mounting gear 103a) comprising the mounting clips 201a, 201b, and the first structure 113 of the low-profile extrusion 101. The first structure 113 is removably inter-locked with the mounting gear 103a with the help of a locking mechanism provided by the flexibility and design of the mounting clips 201a, 201b. The removable locking provides easy coupling of the first structure 113 with the one or more mounting gears 103a, 103b, and easy decoupling of the first structure 113 from the one or more mounting gears 103a, 103b. Further, the mounting clips 201a, 201b use the locking mechanism to hold the entire low-profile extrusion 101 on to a surface. The mounting clips 201a, 201b may have a spring-like structure with a tensile strength, which leads to flexible movement of the mounting clips 201a, 201b during coupling and decoupling with the low-profile extrusion 101. As can be observed in the FIG. 2A, the low-profile extrusion 101 snaps over the mounting gear 103a, and completely covers the mounting gear 103a (and 103b not shown in the figure). In an embodiment, the one or more mounting gears 103a, 103b can be removably coupled with the first structure 113 by pressing the low-profile extrusion 101 over the one or more mounting clips 201a, 201b.

Further, the second structure 115 of the low-profile extrusion 101 comprises a first portion 203 to house at the light source 105. The low-profile extrusion 101 further comprises a second portion 205 that is used to couple the cover 109 with the low-profile extrusion 101. The second portion 205 allows easy installation and removal of the cover 109, and easy replacement of the light source 105. Further, the low-profile extrusion 101 comprises a third portion 207 that allows the low-profile extrusion 101 to couple with the endcaps 107a,107b, where the endcaps 107a, 107b are configured to hold together the light source 105, the low-profile extrusion 101, and the cover 109.

Further, FIG. 2B illustrates a structure of a mounting gear and structures of mounting clips, in accordance with an example embodiment. The mounting gear (103a or 103b) comprises at least one cavity 209 to accept (or insert) at least one fastener. The mounting gear (103a or 103b) further comprises mounting clips (201a, 201b) on two sides of the mounting gear (103a or 103b) (as described earlier with reference to FIG. 2A). The mounting clips (201a, 201b) may be formed by bending two opposite sides of the mounting gear (103a or 103b). The bent sides are contorted from the middle to form curves (211a, 211b) facing away from each other (or opposite to each other or facing outward). The upper ends of the mounting clips (201a, 201b) are formed by further contorting the two sides from the top to form curves (213a, 213b) facing towards each other (or facing inward). The curves (211a, 211b, 213a, 213b) of the mounting clips (201a, 201b) allow the mounting clips (201a, 201b) to removably lock with the first structure 113 of the low-profile extrusion 101 in a flexible manner. In a non-limiting example, the mounting clips (201a, 201b) are made of bent metal sheet.

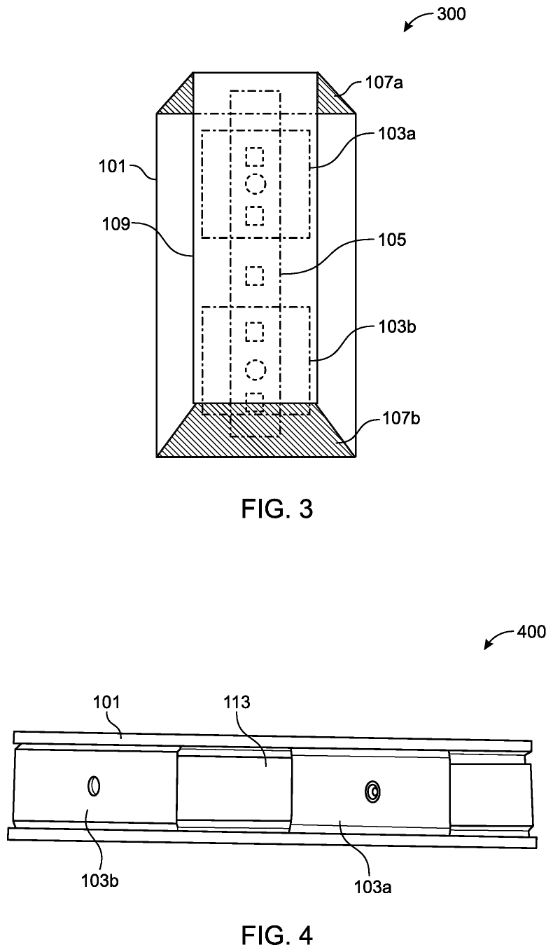

FIG. 3 illustrates a front view 300 of the light-fixture apparatus 100 in conjunction with FIG. 1, in accordance with an example embodiment. The front view 300 corresponds to the front portion of the light-fixture apparatus 100. It can be observed in the FIG. 3 that the low-profile extrusion 101 completely hides the one or more mounting gears 103a, 103b. Thus, the light-fixture apparatus 100 sits perfectly flushed with the surface. The complete hiding of the one or more mounting gears 103a, 103b by the low-profile extrusion 101 provides for easier cleanup of the light-fixture apparatus 100. Further, the removable locking mechanism of the one or more mounting clips (201a, 201b) (as described earlier with reference to FIG. 2A) provide for easier installation of the light-fixture apparatus 100, easier replacement of the light source 105. Further, hiding the one or more mounting gears 103a, 103b by the low-profile extrusion 101 adds an aesthetic appeal to the light-fixture apparatus 100.

FIG. 4 illustrates a rear view 400 of the light-fixture apparatus 100 in conjunction with FIG. 1, in accordance with the example embodiment. The rear view 400 corresponds to the rear portion of the light-fixture apparatus 100. As can be observed from the FIG. 4, the mounting gears 103a, 103b coupled with the first structure 113 of the low-profile extrusion 101. Further, each mounting gear of the mounting gears 103a, 103b comprises a cavity in the middle to insert one or more fasteners, for example screws or the likes in order to mount the mounting gear on to a surface. Each mounting gear further comprises plurality of mounting clips (201a, 201b) (as described earlier with reference to FIG. 2A) that removably locks with the low-profile extrusion 101 and holds the low-profile extrusion 101. The one or more mounting gears 103a, 103b along with the plurality of mounting clips 201a, 201b hold the low-profile extrusion 101 to mount the light-fixture apparatus 100 on to the surface, and the low-profile extrusion 101 holds at least one light source 105 for illumination purpose.

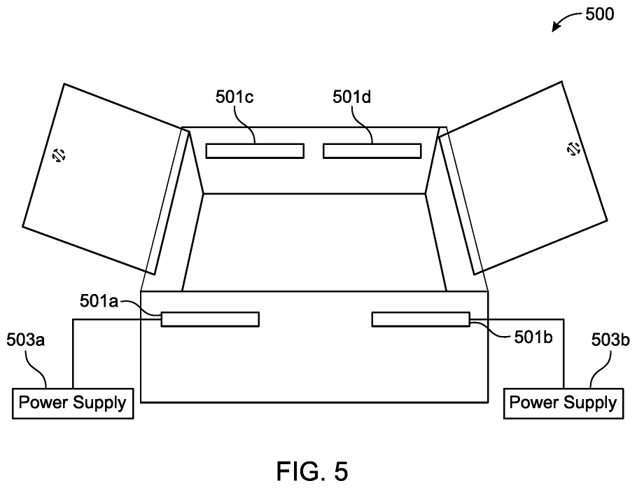

FIG. 5 illustrates an exemplary scenario for implementation of the light-fixture apparatus, in accordance with an example embodiment. In a non-limiting example, the light-fixture apparatuses 501a, 501b (such as light-fixture apparatus 100) are mounted under a cabinet. As can be observed from the FIG. 5, one or more mounting gears are completely hidden, thus the apparatuses 501a, 501b are flushed with the surface of the cabinet. The light-fixture apparatuses 501a, 501b are connected to power supplies 503a, 503b to power light sources housed by the light-fixture apparatuses 501a, 501b. Further, the light-fixture apparatuses 501c, 501d may be battery powered and may power the light sources without any external connection to the power supplies 503a, 503b. The light-fixture apparatuses 501c, 501d may comprise a power button to power on or power off one or more light sources housed in by the light-fixture apparatus.

Alternatively, the light-fixture apparatus 100 disclosed herein may be used for illumination of surroundings, by mounting the light-fixture apparatus 100 under cabinet, on the wall, from the ceiling, or inside vehicles. Further, the light-fixture apparatus 100 may utilize the cover 109 in order to apply optical effects on the light emitting from the one or more light sources housed by the light-fixture apparatus 100. The low-profile extrusion 101 of the light-fixture apparatus 100 provides protection to the one or more light sources from any external damage. Additionally, the low-profile extrusion 101 of the light-fixture apparatus 100 acts as a heat sink for the one or more light sources. Further, the complete hiding of the one or more mounting gears 103a, 103b by the low-profile extrusion 101 facilitates easier cleanup of the light-fixture apparatus 100. The removable locking mechanism of the one or more mounting clips 201a, 201b provides easier installation of the light-fixture apparatus 100 and easier replacement of the one or more light sources. This ensures a clean and professional installation of the light-fixture apparatus 100.

Many modifications and other embodiments of the inventions set forth herein will come to mind to one skilled in the art to which these inventions pertain having the benefit of the teachings presented in the foregoing descriptions and the associated drawings. It is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A light-fixture apparatus, comprising:
a light source;
one or more mounting gears comprising one or more mounting clips; and
a low-profile extrusion comprising a first structure to house the one or more mounting gears,
wherein the one or more mounting gears are configured to fit completely into the low-profile extrusion,
wherein the one or more mounting gears are completely hidden under the first structure of the low-profile extrusion, and
wherein the one or more mounting clips hold the low-profile extrusion on to a surface by removably locking with the first structure of the low-profile extrusion.

2. The apparatus of claim 1, wherein the first structure corresponds to an undercarriage, and wherein the one or more mounting gears are removably coupled to the undercarriage.

3. The apparatus of claim 1, wherein the low-profile extrusion further comprises a second structure to house the light source.

4. The apparatus of claim 1, wherein the one or more mounting clips are flexible.

5. The apparatus of claim 1, wherein the low-profile extrusion comprises aluminum material.

6. The apparatus of claim 1, wherein the one or more mounting gears comprise a bent sheet metal.

7. The apparatus of claim 1, wherein the one or more mounting clips comprise a bent sheet metal.

8. The apparatus of claim 1, wherein the low-profile extrusion protects the light source.

9. The apparatus of claim 1, further comprising a cover overlaid on the light source, wherein the cover is transparent and is removably coupled with the low-profile extrusion.

10. The apparatus of claim 9, wherein the cover corresponds to a diffuser that scatters light from the light source, and wherein the diffuser comprises plastic material.

11. The apparatus of claim 9, wherein the cover corresponds to a lens that controls light emitting from the light source, and directs the light according to a predefined beam pattern associated with the lens.

12. The apparatus of claim 9, further comprising a plurality of endcaps configured to hold together the light source, the low-profile extrusion, and the cover.

13. The apparatus of claim 1, wherein the one or more mounting clips comprise a spring structure.

14. The light-fixture apparatus of claim 1, wherein the low-profile extrusion is configured to snap over the one or more mounting gears.

15. The light-fixture apparatus of claim 1, wherein the one or more mounting clips include:
a first pair of curves facing away from each other, and
a second pair of curves facing towards each other.
